(19) United States
(12) Patent Application Publication
(10) Pub. No.: US 2026/0009645 A1
(43) Pub. Date: Jan. 8, 2026

(54) COLLABORATIVE NAVIGATION METHOD FOR VEHICLES HAVING NAVIGATION SOLUTIONS OF DIFFERENT ACCURACIES

(71) Applicant: SAFRAN ELECTRONICS & DEFENSE, PARIS (FR)

(72) Inventors: Philippe FEYEL, MOISSY-CRAMAYEL (FR); Philippe ELIE, MOISSY-CRAMAYEL (FR)

(21) Appl. No.: 19/117,561

(22) PCT Filed: Oct. 2, 2023
(86) PCT No.: PCT/EP2023/077290

§ 371 Date: Apr. 1, 2025

(30) Foreign Application Priority Data
Oct. 3, 2022 (CA) 3178281

(51) Int. Cl. G01C 21/16

(52) U.S. Cl. CPC G01C 21/16

(57) ABSTRACT

A method of collaborative navigation between a first vehicle (A) and a second vehicle (L) moving in the same space area, the first vehicle (A) being equipped with a first navigation device N_{A} that is less accurate than a second navigation device N_{L} equipping the second vehicle (L), includes at the same time, measuring a first position Y_{Am} of the first vehicle (A) by the first navigation device (N_{A}) and a second position Y_{L} of the second vehicle (L) by the second navigation device (N_{L}), measure a position deviation Y_{A/L} between the two vehicles such that δY_{A}=Y_{Am}−Y_{L}−Y_{A/L} with Y_{A} an actual position of the first vehicle and δY_{A} a navigation error of the first navigation device such that Y_{Am}=Y_{A}+δY_{A}, and model an evolution of the navigation error δY_{A} by a state model comprising a control using a pure integrating corrector to maintain the navigation error δY_{A} at zero.

### BACKGROUND OF THE INVENTION

The present invention relates to the field of vehicle navigation.

Nowadays, many vehicles carry a location device combining an inertial navigation unit and a GNSS receiver belonging to a satellite navigation system such as GPS, GALILEO, GLONASS, BEIDU. It will be recalled that an inertial navigation unit comprises at least one inertial measurement unit which conventionally comprises, on the one hand, accelerometers disposed along axes of a measurement reference frame for measuring a specific force vector in this measurement reference frame and, on the other hand, gyrometers for measuring the orientation of this measurement reference frame with respect to an inertial reference frame. The GNSS receiver measures pseudo-distances separating it from each of the satellites from which it receives navigation signals and calculates its own position from the measured pseudo-distances.

Inertial navigation units provide continuous measurements and are very accurate in the short term; but they tend to drift over time. The position calculated by the receivers is accurate but satellite signals are not always available. Kalman filtering is therefore generally used to develop a hybridised navigation using inertial measurements to maintain the satellite position between two receptions of satellite navigation signals.

In practice, it happens that two vehicles equipped with navigation devices of different accuracy move in the same space. Collaborative navigation has been envisaged allowing a first vehicle provided with the least accurate navigation device to use navigation data from a second vehicle provided with the most accurate navigation device so that the least accurate navigation device can calculate a position while benefiting from the accuracy of the most accurate navigation device. The envisaged collaborative navigation may use Kalman filtering, which is generally very demanding in terms of computational resources.

### OBJECT OF THE INVENTION

A particular object of the invention is to provide collaborative navigation that requires fewer computational resources.

### SUMMARY OF THE INVENTION

To this end, according to the invention, a method according to claim 1 is provided.

Thus, the second vehicle serves as a measurement reference so that the position measurement of the second vehicle and the measurement of the position deviation between the two vehicles allow to calculate the navigation error of the first navigation device at a given time. Knowledge of this navigation error then allows to determine, by means of an integrating corrector, a control to cancel said error in the future. The method of the invention therefore implements an integral controller which is particularly robust, in particular with respect to constant biases, while requiring less computational resources than Kalman filtering, and which takes into account the drift model of the navigation device whose performance is to be improved.

Other features and advantages of the invention will appear upon reading the description below of a particular and non-limiting embodiment of the invention.

### BRIEF DESCRIPTION OF THE DRAWINGS

Reference will be made to the accompanying drawings, in which:

FIG. 1 is a block representation of a feedback loop according to the invention;

FIG. 2 is a schematic view illustrating a first implementation of the method of the invention with two vehicles;

FIG. 3 is a schematic view illustrating a second implementation of the method of the invention with three vehicles;

FIG. 4 is a schematic view illustrating a third implementation of the method of the invention with three vehicles.

### DETAILED DESCRIPTION OF THE INVENTION

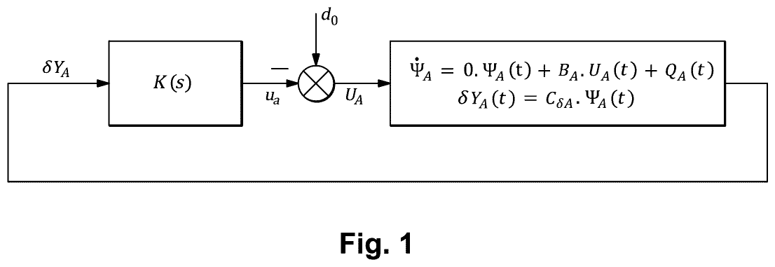

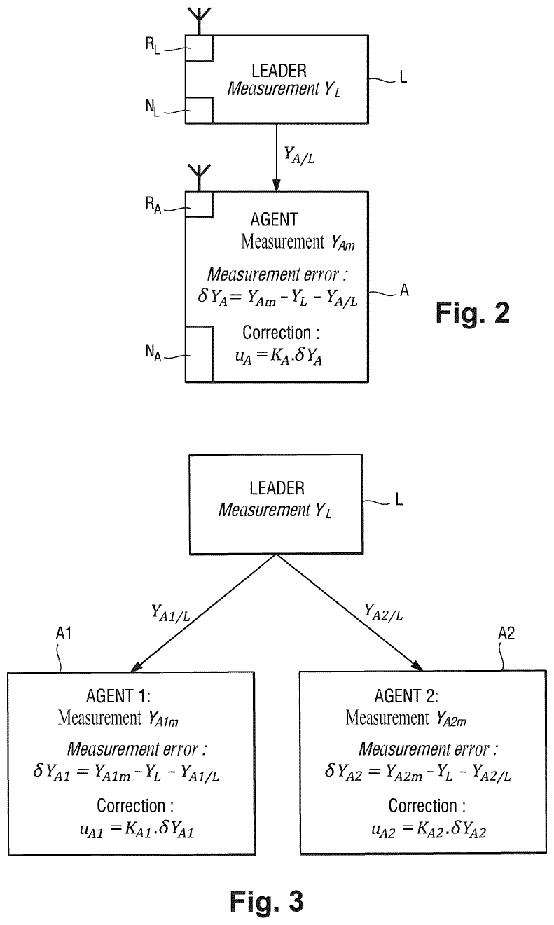

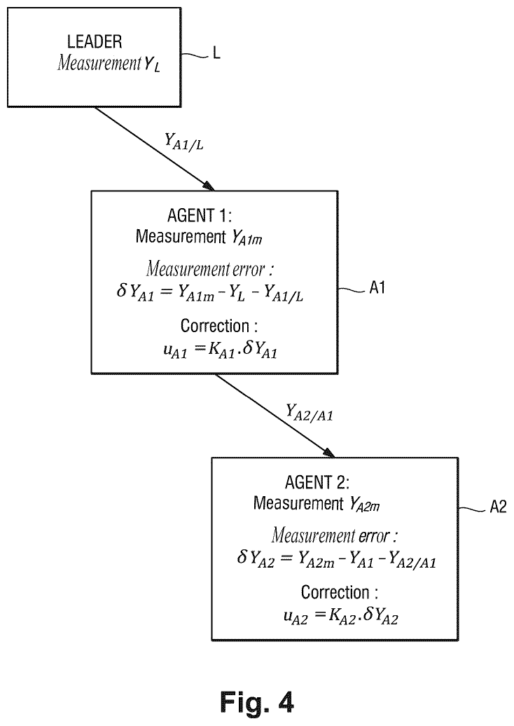

The principle of the invention will be explained with reference to FIGS. 1 and 2.

The method of the invention is implemented here between two vehicles, namely a leader vehicle L such as an airplane and an agent vehicle A such as a drone or a missile.

The leader vehicle L is equipped with a navigation device N_{L} comprising an inertial navigation unit.

The agent vehicle A is also equipped with a navigation device N_{A} comprising an inertial navigation unit.

The inertial navigation unit of the leader vehicle L and the inertial navigation unit of the agent vehicle A each comprise an inertial measurement unit which conventionally comprises, on the one hand, accelerometers arranged along axes of a measurement reference frame (reference frame local to the housing of the inertial measurement unit) for measuring a specific force vector in this measurement reference frame and, on the other hand, gyrometers for measuring the orientation of this measurement reference frame relative to an inertial reference frame (absolute reference frame, fixed relative to the stars). However, the gyrometers of the inertial navigation unit of the leader vehicle L are here with a hemispherical vibrating resonator GRH or are gyrolasers while the sensors of the inertial navigation unit of the agent vehicle A are micro-electromechanical systems (or MEMS). As a result, the inertial navigation unit of the agent vehicle A is less accurate than the inertial navigation unit of the leader vehicle L.

The navigation devices N_{L} and N_{A} of the vehicles L and A each comprise an electronic control unit comprising a processor and a memory containing programs executed by the processor for exploiting the signals supplied by the inertial measurement unit and for executing an algorithm implementing the method of the invention.

It will be recalled that, in general, the measurements provided by the algorithms of an inertial navigation unit that uses inertial measurements are homogeneous at latitude (Lₐ), longitude (G), and altitude (Z) in the image of the location solution provided by a GNSS receiver. Since the horizontal plane in the inertial geolocation is decoupled from the vertical plane, the present description will be concerned only with latitude (Lₐ) and longitude (G). Also for an inertial measurement unit, the measurement Yₘ corresponds to:

$${Y}_{m} = [ \begin{matrix}{L}_{a} \\ G\end{matrix} ] + [ \begin{matrix}δ {L}_{a} \\ δ G\end{matrix} ] = Y + δ Y$$

where Yₘ is the measured position, δLₐ is the latitude error of the inertial measurement unit, δG is the longitude error of the inertial measurement unit, δY is the position error of the inertial measurement unit.

Each inertial navigation unit has its own processing means, for example a Kalman filter, allowing the estimation of latitudes and longitudes tainted with error. The δY errors come from the biases (bias of gyrometers mainly and bias of accelerometers at a lower order, accelerometers being generally more stable than gyrometers because once the accelerometers are calibrated, they vary very little) that we want to estimate for compensation. By a linear approximation, the measurement errors are related to the gyrometric bias by a state model:

$${\dot{Ψ}}_{[ i ]} = 0 \cdot {Ψ}_{[ i ]} + B \cdot {d}_{[ m ]} + Q$$

$$δ Y = {C}_{δ} \cdot {Ψ}_{[ i ]}$$

wherein:
Q is a common state noise,
B is a control matrix dependent on the rotation Tᵢₘ allowing to change from the measurement reference frame [m] to the inertial reference frame [i],
d_{[m]} is the gyrometric bias expressed locally and is written d_{[m]}=[dₓ, d_{y}, d_{z}],
C_{δ} is an observation matrix that depends on the rotation period of the earth and the latitude Lₐ,
Ψ_{[i]} represents the state of measurement errors as

$$( \begin{matrix}δ {L}_{a} \\ δ G\end{matrix} ) = ( \begin{matrix}sin ( {ω}_{e} t ) & - cos ( {ω}_{e} t ) & 0 \\ tan ( {L}_{a} ) cos ( {ω}_{e} t ) & tan ( {L}_{a} ) sin ( {ω}_{e} t ) & - 1\end{matrix} ) {Ψ}_{[ i ]}$$

with
Ψ_{[i]}=[Ψₓ, Ψ_{y}, Ψ_{z}]=Tᵢₘd_{[m]}+Q and ωₑ the rotation period of the Earth

The vehicles A and L each further comprise a telecommunication transceiver R_{A} and R_{L} allowing them to communicate with each other and exchange data for example in the form of radio signals. The telecommunication transceiver R_{A} of the agent vehicle A is connected to the electronic control unit of the navigation device of the agent vehicle A and the telecommunication transceiver R_{L} of the leader vehicle L is connected to the electronic control unit of the navigation device of the leader vehicle L.

The method of the invention is implemented when the leader vehicle L and the agent vehicle A are moving in the same space area and are in perfect communication, that is, they can exchange information with each other reliably. the In first implementation of the method of the invention, more particularly illustrated in FIG. 2, the leader vehicle L is in perfect communication with the agent vehicle A moving in the same space area as the leader vehicle L.

The method of the invention begins with the navigation device of the leader vehicle L entering into communication with the navigation device of the agent vehicle A. The navigation device of the leader vehicle L and the navigation device of the agent vehicle A synchronise to measure at the same measurement time:
a first position Y_{Am} of the agent vehicle A by the navigation device of the agent vehicle A;
a second position Y_{L} of the leader vehicle L by the navigation device of the leader vehicle L;
a position deviation Y_{A/L} between the leader vehicle L and the agent vehicle A. This deviation is measured in distance (polar coordinates) and projected with the attitude of the wearer of the measurement device, here the leader. The leader vehicle L carries out this measurement by any appropriate means and for example by means of an optical camera associated with image processing, by laser telemetry, by radar, etc.

“Same moment” means either the same moment or moments sufficiently close to each other for the time deviation between the two moments to be compatible with the desired increase in accuracy that can be obtained by implementing the method of the invention.

The position measurement Y_{L} and the position deviation measurement Y_{A/L} are transmitted by the navigation device of the leader vehicle L to the navigation device of the agent vehicle A, the rest of the method being implemented here at the level of the navigation device of the agent vehicle A. According to the method of the invention, the algorithm implementing the method of the invention exploits the position measurement Y_{L} and the position deviation measurement Y_{A/L} as if they were error-free.

On the contrary, the position measurement Y_{Am} is considered to be affected by a navigation error δY_{A} of the navigation device N_{A} of the vehicle A, such that Y_{Am}=Y_{A}+δY_{A} with Y_{A} being the actual position of the agent vehicle A. The navigation error δY_{A} of the navigation device N_{A} of the agent vehicle A is therefore defined by said algorithm as δY_{A}=Y_{Am}−Y_{L}−Y_{A/L}, Which allows to calculate the navigation error δY_{A} at the measurement moment.

The algorithm implementing the method of the invention is arranged to model an evolution of the navigation error δY_{A} by a state model and use a pure integrating corrector to maintain the navigation error δY_{A} at zero.

The state model is as follows

$${\dot{Ψ}}_{A} = 0 \cdot {Ψ}_{A} ( t ) + {B}_{A} \cdot ( {d}_{0} ( t ) + {u}_{A} ( t ) ) + {Q}_{A} ( t )$$

$$δ {Y}_{A} ( t ) = {C}_{δ A} \cdot {Ψ}_{A} ( t )$$

In this model:
Ψₐ(t) is the state of the navigation error,
B_{A} is the control matrix,
d₀(t) represents the sensor bias of the first navigation device causing the navigation error δY_{A}, this sensor bias being unknown,
u_{A}(t) is a control,
Q_{A}(t) is the noise of the state model,
C_{δA} is the observation matrix;

The control u_{A}(t) is introduced at the sensor bias so as to minimise the navigation error δY_{A} (t) such that the control u_{A}(t) corresponds to an estimation of the residual of the sensor bias source of the navigation error δY_{A} (t). It is important to note that the primary purpose of the command is not to cancel the term δd(t)=d₀(t)+u_{A}(t) but to cancel the measurement error δY_{A}(t) generated by the unknown disturbance constituted by the gyro bias d₀(t).

The correction carried out in accordance with the method of the invention aims in practice to cancel the navigation error δY_{A} by applying for the control u_{A}(t) a control law such that

$${u}_{A} ( s ) = {K}_{A} ( s ) \cdot δ {Y}_{A} ( s )$$

in which s is the Laplace variable and K_{A}(s) is the corrector. All known methods in the field of automation can be used to solve this equation provided that the corrector K_{A}(s) is a pure integrator such

$${K}_{A} ( s ) = \frac{{k}_{A} ( s )}{s}$$

that causes the navigation error δY_{A} to tend asymptotically towards zero. A feedback loop is thus obtained, shown in FIG. 1, in which the measurement entering the observer is corrected directly (the control term d₀−u_{A} has been noted in FIG. 1 U_{A}).

It should be noted that the use of a closed loop instead of a direct open loop compensation improves the stability and the robustness of the compensation, in particular with regard to disturbances caused by certain defects such as a delay.

It is possible to make the method of the invention more efficient by taking into account the accelerometric bias f_{[m]}=[fₓ, f_{y}, f_{z}] in the calculation of the sensor bias resulting in the navigation error. This gives:

$$( \begin{matrix}δ {L}_{a} \\ δ G\end{matrix} ) ( \begin{matrix}sin ( {ω}_{e} t ) & - cos ( {ω}_{e} t ) & 0 \\ tan ( {L}_{a} ) cos ( {ω}_{e} t ) & tan ( {L}_{a} ) sin ( {ω}_{e} t ) & - 1\end{matrix} ) {Ψ}_{[ i ]} + ( \begin{matrix}\frac{1}{g} & 0 & 0 \\ 0 & \frac{1}{g cos ( {L}_{a} )} & 0\end{matrix} ) {T}_{gm} \cdot {f}_{m}$$

In a second implementation shown in FIG. 3, the leader vehicle L is in perfect communication with a first agent vehicle A1 and a second agent vehicle A2. The agent vehicles A1 and A2 move with the leader vehicle L in the same space area. The agent vehicle A1 and the agent vehicle A2 have navigation devices of equivalent accuracy.

The method according to the invention is implemented independently, on the one hand, between the leader vehicle L and the agent vehicle A1, and, on the other hand, between the leader vehicle L and the agent vehicle A2.

So we have, for the agent vehicle A1:
a position measurement Y_{A1m} and a true position Y_{A1},
a position deviation measurement Y_{A1/L},
a navigation error δY_{A1}=Y_{A1m}−Y_{L}−Y_{A1/L},
a correction u_{A1}(s)=K_{A1}(s)·δY_{A1}(s).

For the agent vehicle A2, we have:
a position measurement Y_{A2m} and a true position Y_{A2},
a position deviation measurement Y_{A2/L},
a navigation error δY_{A2}−Y_{A2m}−Y_{L}−Y_{A2/L},
a correction u_{A2}(s)=K_{A2}(s)·δY_{A2}(s).

In a third implementation illustrated in FIG. 3, the leader vehicle L is in perfect communication with a first agent vehicle A1 which is itself in perfect communication with a second agent vehicle A2. The leader vehicle L is not in communication with the second agent vehicle A2. The agent vehicle A1 moves in the same space area with the leader vehicle L. The agent vehicles A1 and A2 move in the same space area but the agent vehicle A2 does not move in the same space area as the leader vehicle L.

The agent vehicle A1 and the agent vehicle A2 have navigation devices of equivalent accuracy. Collaborative navigation is established between the agent vehicle A1 and the agent vehicle A2 by considering that the navigation device of the agent vehicle A1 is in practice more accurate than the navigation device of the agent vehicle A2 because of the collaborative navigation of the agent vehicle A1 with the leader vehicle L.

The method of the invention is implemented in cascade:
first, between the leader vehicle L and the agent vehicle A1, and
secondly, between the agent vehicle A1 and the agent vehicle A2.

So we have, for the agent vehicle A1:
a position measurement Y_{A1m} and a true position Y_{A1},
a position deviation measurement Y_{A1/L},
a navigation error δY_{A1}=Y_{A1m}−Y_{L}−Y_{A1/L},
a correction u_{A1}(s)=K_{A1}(s)·δY_{A1}(s).

For the agent vehicle A2, we have:
a position measurement Y_{A2m} and a true position Y_{A2},
a position deviation measurement Y_{A2/A1},
a navigation error δY_{A2}=Y_{A2m}−Y_{A1}−Y_{A2/A1},
a correction u_{A2}(s)=K_{A2}(s)·δY_{A2}(s).

The position deviation is measured in distance (polar coordinates) and projected with the attitude of the wearer of the measurement device, either the leader L with regard to the deviation Y_{A1/L} or the agent A1 with regard to the deviation Y_{A1/A2}.

In this third implementation, the dynamics of the drift compensation of the agent vehicle A2 is highly dependent on the drift compensation of the agent vehicle A1. This can be damaging depending on the use that is to be made of the measurements of the inertial measurement unit of the agent vehicle A2. Asymptotically, we find Y_{A2m}(s)=Y_{A2}(s) that K_{A1} (s) and K_{A2} (s) are integrators, but the compensation dynamics of the agent vehicle A2 is naturally disturbed by that of the agent vehicle A1. Preferably, an anticipation/resynchronisation action (limited sum) will be provided on the measurement of the agent vehicle A1 transmitted to the agent vehicle A2 to compensate for this disturbance.

Naturally, the invention is not limited to the embodiment described, but covers any variation falling within the scope of the invention as defined by the claims.

In particular, the navigation devices may have a structure different from those described and include, for example, a stellar sighting device or a GNSS receiver.

In particular, the with invention, an alternative hybridisation to Kalman filtering is obtained for particular cases of constant drift of the inertial measurement unit. Nevertheless, the method of the invention can be implemented instead of or in parallel with Kalman filtering.

The method of the invention can be used with more than two agents in cascade. Obviously, the greater the number of agents in cascade, the more the dynamics of the inertial measurement unit of the agent at the end of the chain will be impacted. This impact will have to be taken into account in the use of the inertial measurement unit in question. A simultaneous synthesis of the different controllers could be considered to identify the optimal solution.

The state model can be different from that described and include more or fewer terms, and for example also integrate the altitude error.

The invention is applicable to any type of vehicle, piloted or not, and for example air, land, water, space vehicles or a mixture thereof.

1. A method of collaborative navigation between at least a first vehicle (A) and a second vehicle (L) moving in the same space area, the first vehicle (A) being equipped with a first navigation device N_{A} that is less accurate than a second navigation device N_{L} equipping the second vehicle (L), the method comprising:
at the same time, measuring a first position Y_{Am} of the first vehicle (A) by the first navigation device (NA) and a second position Y_{L} of the second vehicle (L) by the second navigation device (N_{L});
measure a position deviation Y_{A/L} between the two vehicles such that δY_{A}=Y_{Am}−Y_{L}−Y_{A/L} with δY_{A} an actual position of the first vehicle and δY_{A} a navigation error of the first navigation device such that Y_{Am}=Y_{A}+δY_{A};
model an evolution of the navigation error δY_{A} by a state model comprising a control using a pure integrating corrector to maintain the navigation error δY_{A} at zero.

2. The method according to claim 1, wherein the state model has the form:
$${\dot{Ψ}}_{A} = 0 \cdot {Ψ}_{A} ( t ) + {B}_{A} \cdot ( {d}_{0} ( t ) + {u}_{A} ( t ) ) + {Q}_{A} ( t )$$
$$δ {Y}_{A} ( t ) = {C}_{δ A} \cdot {Ψ}_{A} ( t )$$
wherein Ψ_{A}(t) is the state of the navigation error, B_{A} is a control matrix, d₀(t) represents an unknown sensor bias of the first navigation device causing the navigation error δY_{A}, u_{A}(t) is a control, Q_{A}(t) is a model noise, C_{δA} is an observation matrix;
and wherein the correction aims to cancel the navigation error δY_{A} by applying a control law such as
$${u}_{A} ( s ) = K ( s ) \cdot δ {Y}_{A} ( s )$$
in which s is the Laplace variable and K(s) is the pure integrating corrector such that
$$K ( s ) = \frac{k ( s )}{s} .$$

3. The method according to claim 1, wherein the navigation device comprises at least one inertial measurement unit and the sensor bias comprises a residual gyrometric bias.

4. The method according to claim 3, wherein the sensor bias also comprises a residual accelerometric bias.

5. The method according to claim 1, implemented by a plurality of first vehicles (A1, A2) moving in the same space area as the second vehicle (L).

6. The method according to claim 1, wherein a third vehicle (A2) moves in the same space area as the first vehicle (A1), the third vehicle (A2) being equipped with a third navigation device having substantially the same intrinsic accuracy as the first navigation device, and wherein collaborative navigation is established between the first vehicle (A1) and the third vehicle (A2) by considering that the first navigation device is in practice more accurate than the third navigation device because of the collaborative navigation of the first vehicle (A1) with the second vehicle (L).

7. The method according to claim 1, wherein the first vehicle (A1) is a drone and the second vehicle is a piloted vehicle (L).
